(19) United States
(12) Patent Application Publication
(10) Pub. No.: US 2012/0258553 A1
(43) Pub. Date: Oct. 11, 2012

(54) ANALYTE MEASUREMENT APPARATUS AND METHOD

(75) Inventors: Wendy Uyen Dittmer, Eindhoven (NL); Toon Hendrik Evers, Eindhoven (NL); David Walterus Cornelis Dekkers, Veldhoven (NL); Marco Hendrikus Hefti, Wijchen (NL); Joost Lambert Max Vissers, Nijmegen (NL); Michael Franciscus Wilhelmus Cornelis Martens, Helmond (NL)

(73) Assignee: KONINKLIJKE PHILIPS ELECTRONICS N.V., EINDHOVEN (NL)

(21) Appl. No.: 13/518,428

(22) PCT Filed: Dec. 16, 2010
(86) PCT No.: PCT/IB2010/055873

§ 371 Date: Jun. 22, 2012

(30) Foreign Application Priority Data
Dec. 23, 2009 (EP) 09180621.6

(51) Int. Cl. G01N 27/72

(52) U.S. Cl. 436/501; 422/69

(57) ABSTRACT

An apparatus for measuring a target molecule in a sample is disclosed. The apparatus comprises a moiety comprising a magnetic label (1) greater than 100 nm, a binding surface (12) for specifically binding the moiety, the amount of said moiety binding to said surface being indicative of the amount of the target molecule in said sample, detection means (31 31′) for detecting the amount of said moiety bound to said surface, and a salt (51) for reducing aggregation of the magnetic labels of respective moieties in said sample. The apparatus preferably also comprises a magnetic field generator (41) for attracting the magnetic labels to the binding surface. A method for measuring a target molecule in a sample and a disposable cartridge for use with the apparatus are also disclosed.

### FIELD OF THE INVENTION

The invention relates to a method of determining the presence of a target molecule in a sample using moieties that comprise magnetic and/or magnetizable labels.

The invention further relates to devices for such method.

### BACKGROUND OF THE INVENTION

In the field of medial diagnostics, assay-based sensor devices are rapidly gaining popularity because of the prospect of being able to accurately determine the presence and concentration of a wide variety of analytes of interest in various samples such as bodily fluid samples including saliva, blood, blood serum, blood plasma, urine and so on.

To this end, a moiety comprising a detectable label such a fluorescent or chemo luminescent probe, an enzyme for converting a calorimetric substrate or a magnetic and/or magnetizable particle (label) is provided, which may specifically bind to a binding surface of a measuring apparatus, e.g. a sensor. The amount of moiety that binds to this binding surface is indicative of the amount of analyte of interest or target molecule present in the sample, for instance because the moiety can only bind to the binding surface via the analyte such as in a so called sandwich assay, because the moiety competes with the analyte to bind to the limited number of spaces on the binding surface, such as in a competitive assay, or because the analyte also specifically binds to the same epitope of the moiety, thus inhibiting the binding of the moiety to the binding surface, such as in an inhibitive assay. Further examples of known assays can for instance be found in WO 2007/060601, and other examples will be apparent to the skilled person.

In other words, either the target molecule or the moiety specifically binds with e.g. an antibody defining the binding surface of the apparatus such that the concentration of the analyte can be detected from the presence of the detectable label in the binding surface area upon the formation of the specific binding. Many suitable specific binding pair candidates are known per se, which are typically based on a lock-and-key type interaction between a receptor molecule and a molecule, e.g. a drug. This makes an assay-based apparatus particularly suitable to determine the presence or absence of specific proteins and other biological compounds such as DNA, RNA, hormones, metabolites, drugs and so on, or to determine the activity and function of active and catalytic biomolecules such as proteins, peptides, prions, enzymes, aptamers, ribozymes and deoxyribozymes. For instance, immunoassays are already used to determine the specific amount of specific proteins in body fluids to aid further diagnosis and treatment.

The use of such an assay-based apparatus provides promising new opportunities in the field of medical diagnostics, such as the provision of a handheld biosensor system for use in rapid medical diagnosis outside of laboratory environments such as the physician's office, hospital bedside, ambulance and patient's home. An example of such a diagnostic test of interest is the detection of cardiac troponin I (cTnI), which is a diagnostic marker for myocardial infarct.

It will be appreciated that in addition to being rapid, such diagnostic tests are required to be sensitive as the testing for certain disease biomarkers requires detection to be completed in the picomolar range. A particularly promising apparatus for performing such a diagnostic test utilizes moieties labeled with a magnetic or magnetizable particle for specifically binding to the binding surface (the sensor area) because the magnetic field can accelerate (attract) the magnetic labels towards the binding surface, thus accelerating the binding reaction rate between the moiety and the binding surface. After the removal of the unbound moieties, e.g. by washing or rinsing, the amount of moieties bound to the binding surface can be determined by the amount of the magnetic labels present in the vicinity of the surface of the binding surface, for instance by means of light reflection techniques or magnetic sensing techniques.

For testing outside laboratory environments it is required that the diagnostic test is compact, robust and has as few user-aided steps as possible. Ideally the user only needs to add the sample to a disposable cartridge and all reagents necessary for the diagnostic test are already present in the cartridge, with it furthermore being highly desirable that the reagents are present in a solid state form often referred to as dry form. For the detection of protein markers, the preferred sample type is blood as levels in blood are a direct indication of systemic levels. In many cases, blood is further treated to remove blood cells, with the resulting serum or plasma being tested for the analyte.

### SUMMARY OF THE INVENTION

The present inventors have found that a problem exists with the use of magnetic or magnetizable particle moieties in a test assay as described here above when used for e.g. biological samples. It was found that regardless of the level of analyte to be determined in the sample the measured value, i.e. the recovery, is low. The recovery of analyte appears to be highly dependent upon the donor specimen of the sample, as well as dependent upon the type of analyte of interest. There are specific donors for whom the interference is negligible and other donors where the effect is substantial. On average, for example for cardiac troponin I as the analyte of interest, approximately 15% of all donor samples show substantial interference such that the assay does not function.

Thus, the reproducibility of the method and devices was found to be compromised.

In addition, the problem is aggravated for assays making use of magnetic actuation to manipulate or measure the amount of labeled moieties. The application of a magnetic field during the assay may force the magnetic particles together repeatedly. This is particularly the case when the magnetic particles have a diameter greater than 100 nm, which have a tendency to cluster even in the absence of such a magnetic field. Alternatively or additionally, the moieties including the magnetic and/or magnetizable particles or labels may be deposited in the apparatus in a solid form before application of a sample and are only re-dispersed upon addition of the fluid sample to the apparatus such that the magnetic and/or magnetizable particles are dispersed from an initial aggregated state.

The aforementioned problem of reliability and reproducibility may be reduced by the invention as defined in the independent claims. The dependent claims provide advantageous embodiments.

It has been surprisingly found that the addition of salts to the sample of interest improves the reliability and/or reproducibility of the assay method and devices for performing such assays.

It is believed that the reason for the donor to donor variation is that the composition of the sample, e.g. protein, lipids, electrolyte, hormones of plasma and serum, varies substantially from patient to patient. The analyses of various donor samples by the present inventors suggests that e.g. proteins within a sample such as a plasma or serum sample adsorb to the surface of the particles and induce irreversible magnetic or magnetizable particle-particle interactions. This problem also emerges if whole blood is employed as a sample matrix, either ‘as is’ or in lysate form. The addition of salt is now believed to prevent or at least reduce the aggregation of the magnetic and/or magnetizable labels of the moieties that are present for binding to the binding surface. Hence, a more accurate and precise signal relative to the concentration is detected per binding event leading to the improved reproducibility and reliability.

Thus a device that comprises such a salt which upon dissolution provides for reduction of aggregation of the magnetic and/or magnetizable particles dispersed with the sample after addition of the sample to the device is beneficial as explained here above.

The sample may be an analytical sample of any origin that would result in the clustering recovery problems indicated here above when used in the assay without the addition of salts. The sample may be a bodily sample of animals or human beings. It may be a sample having protein and/or lipid content. The sample may preferably be saliva, blood, blood serum, blood plasma. Alternatively, the sample may be other fluids form the body. Generally such samples will be water based, but other solvents, added after obtaining the sample from a specimen for example, may be present albeit that the dissolution of the salt in the resulting sample must be enabled. It will be understood that laboratory samples not stemming from the body, but containing the same clustering constituents as such bodily fluids may also be analyzed with the assay of the invention with advantage.

The moiety may be indicative of analytes that are biological compounds or fragments thereof, or are that are part of biological entities such as cells. Biological compounds include DNA, RNA, hormones, metabolites, drugs and so on, or compounds that determine the activity and function of active and catalytic biomolecules such as proteins, peptides, prions, enzymes, aptamers, ribozymes and deoxyribozymes. Preferably the moiety is indicative for the presence of bodily proteins and/or fragments thereof The moieties preferably are mono- and/or polyclonal antibodies that specifically interact with the analyte of interest. Preferably the moiety is chosen to be indicative for analytes that can be used for screening and/or diagnosis and/or determining prognosis of heart disorders. Thus, the assay of the invention is advantageous in testing for example congestive heart failure (CHF) which may be diagnosed with the use of a moiety indicative of Brain natriuretic peptide (BNP) now known as B-type natriuretic peptide(also BNP) or GC-B, or NT-proBNP which is the biologically incactive N-terminal fragment of proBNP may be used. Also, the assay is advantageous in testing myocardial infarction or heart failure using a moiety indicative for the presence of troponine I and/or T. Furthermore, the moiety may be indicative of the presence of Parathyroid hormone (PTH), or parathormone, which may be used for testing on hyperparathyroidism or hypoparatyroidism which may be used to diagnose the known relating disorders within humans or animals.

The salt concentration when dissolved in the sample should preferably be in the range of 0.1-5 mole per liter because it has been found that within this range, aggregation of the magnetic labels can be suppressed.

The amount of salt provided in the device may be tuned such that upon filling of a sample chamber of certain defined volume the concentration suitable to give the clustering reduction effect is reached. Thus, the sample chamber and amount of salt may be such that the concentration during essay is in the range 0.1 to 5 Mole per liter.

Suitable salts include alkalimetal salts such as those of lithium, sodium or potassium. Preferably the salt comprises or consists of sodium (Na) and/or potassium (K) salts, such as potassium chloride (KCl), potassium iodide (KI), potassium bromide (KBr), Sodium chloride (NaCl), sodium bromide (NaBr) and combinations thereof. Such salts have been found to give the highest level of improvement, i.e. the biggest reduction in magnetic and/or magnetizable particle aggregation behavior.

In a preferred embodiment, a combination of KCl and KBr is used. This is particularly effective to reduce cluster formations in samples in which cardiac troponin I, NT-proBNP or parathyroid hormone PHT as the analyte of interest.

Alternatively, the salt is a thiocyanate salt such as potassium thocyanate (KSCN) and guadinine-thiocyaniate. It has been found that such salts are particularly effective in improving the behavior of samples, and in particular plasma samples, that significantly suffer from the aforementioned interference.

The salt and said moieties may be placed together in the apparatus in a solid form also referred to as dried form. In such cases the invention may have particular effect as the prolonged storage of a device having the magnetic and/or magnetizable label moiety may cause extensive aggregation of the label before and/or during subsequent use. For instance, the apparatus may comprise an inlet connected to a sample chamber comprising the binding surface, wherein said salt is placed in said inlet. The inlet may comprise filtration means for filtering said sample, wherein the filtration means further comprise said salt. By placing the salt upstream from the moiety with the magnetic label, the salt may be dissolved in the sample prior to the sample reaching the measurement chamber comprising the moiety.

Alternatively, the salt and said moieties are placed together in the device in the solid form. It has been found that by mixing the salt and the moiety and placing them together in the same location within the apparatus, aggregation of the magnetic and/or magnetizable labels in the sample is more effectively reduced.

In an embodiment, the device is a disposable cartridge for receiving the sample, wherein the binding surface, the amount of salt and said moiety is placed. This has the advantage that a separate apparatus may be used that is able to receive the cartridge and measure the moieties on the binding surface of the cartridge. Thus, for each sample, multiple measurements only requires the cartridge to be replaced. Thus, such a disposable cartridge may be provided independent of the apparatus.

The device may comprise detection means for determining the presence of moieties on the binding surface. Preferably such detection means may be optical means such as a frustrated total internal reflection unit, or other microscopy unit able to detect magnetic and/or magnetizable particles on the binding surface. Alternatively, the detection means may be magnetic means which through feedback are able to sense the presence of magnetic and/or magnetizable labels on the binding surface.

The device may have a magnetic field generator for attracting said magnetic or magnetizable labels to the binding surface. This reduces the time required for the binding reaction at the binding surface by virtue of the increase of the moiety concentration at the binding surface.

According to another aspect of the present invention, there is provided a method of measuring a target molecule in a sample using a combination of magnetic or magnetizable labels and the salt according to the invention. The method may be part of or may be a biological assay such as for example inhibition assay, competition assay, sandwich assay. Furthermore, the assay may be directed towards liquid or liquidized (dissolved in e.g. water) biological samples. The features of the method of the invention may be similar to the ones defined for the device. They may have the same advantageous effects.

Preferably, the method further comprises removing unbound magnetic labels from the vicinity of the binding surface prior to said measuring step in order to further improve the accuracy of the measurement. Such removal may be achieved e.g. by washing or rinsing, or by magnetic actuation.

The method may be a method of diagnosis of congestive heart failure using moieties indicative of NT-proBNP, or a method of diagnosis of myocardial infarct when the moiety is chosen to be indicative of cardiac troponine I or T. The sample in these cases preferably is blood. The boundary levels of these cardiac disease markers that are decisive in such diagnosis is well known in the art. The method may comprise a step in which the determined analyte level is compared with the boundary levels and indicated to be higher than or lower than such boundary levels.

### BRIEF DESCRIPTION OF THE DRAWINGS

Embodiments of the invention are described in more detail and by way of non-limiting examples with reference to the accompanying drawings, wherein:

FIG. 1 schematically depicts a non-limiting example of an apparatus suitable for application of the present invention;

FIG. 2 schematically depicts an aspect of an apparatus in accordance with an embodiment of the present invention;

FIG. 3 schematically depicts the effect of adding a salt to a sample in accordance with an example embodiment of the present invention;

FIG. 4 schematically depicts the effect of adding a salt to a sample in accordance with another example embodiment of the present invention; and

FIG. 5 schematically depicts the effect of adding a salt to a sample in accordance with yet another example embodiment of the present invention.

### DETAILED DESCRIPTION OF EMBODIMENTS

It should be understood that the Figures are merely schematic and are not drawn to scale. It should also be understood that the same reference numerals are used throughout the Figures to indicate the same or similar parts.

In the present invention, “target molecule” may be any molecule of which concentration or presence as such is to be determined. Examples of target molecules are molecular targets such as proteins, enzymes, hormones, peptides, nucleic acids and cellular targets such as pathogen cells, bacterial cells and fungal cells. The target molecule may exist as such in a sample that is analyzed or may be formed in situ in a sensor device e.g. via a reaction that takes place in the device. If the sensor is used to monitor a reaction, the target may for example be the starting product of the reaction or a reaction product.

Where reference is made to “in solution” what is meant is that the reaction or assay is carried out in a liquid environment. The reagents that take part need not be dissolved in the fluid medium but may also be present in a suspended or dispersed state.

A selective binding is formed by the combination of two moieties (molecules), i.e. a moiety A and a further moiety B, with specific binding between the two moieties wherein the moiety binds to further moiety more strongly or preferentially than to other molecules and shows little or no cross reactivity with other molecules. In general, the affinity constant (Ka) for specific binding between moiety A and B is at least 10⁶ l/mol, more preferred at least 10¹⁰ l/mol, even more preferred at least 10¹¹ l/mol, even more preferred at least 10¹² l/mol, even more preferred from 10¹³ to 10¹⁷ l/mol.

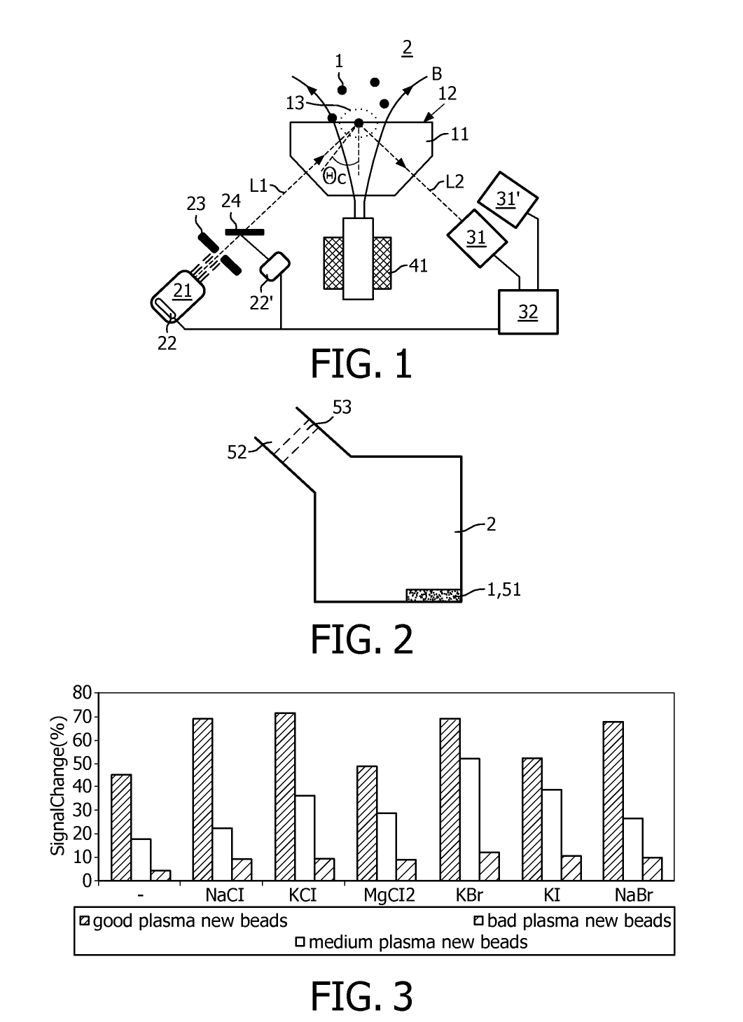

FIG. 1 shows an exemplary embodiment of an apparatus, here a microelectronic sensor device, to which the present invention may be applied. A central component of this device is the carrier 11 that may for example be made from glass or transparent plastic like poly-styrene. The carrier 11 is located next to a sample chamber 2 in which a sample fluid with target components to be detected such as drugs, antibodies, DNA and so on in solution can be provided.

The sample further comprises magnetic particles 1, for example superparamagnetic beads. These particles are typically bound, e.g. adhered, to a moiety (not shown) such as an antibody for binding to the surface 12 defining the interface between the carrier 11 and the sample chamber 2, the so-called called binding surface 12. This binding surface 12 may optionally be coated with capture elements, e.g. antibodies, which can specifically bind the moieties either directly or via the target components. In other words, the binding surface 12 may form part of any suitable assay such as a sandwich assay in which the moiety binds to the binding surface via the target molecule, a competitive assay in which the moiety competes with the target molecule for the binding sites at the binding surface 12, an inhibitive assay in which the target molecule inhibits the binding of the moiety to these binding sites and so on.

The sensor device comprises a magnetic field generator 41, for example an electromagnet with a coil and a core, for controllably generating a magnetic field B at the binding surface 12 and in the adjacent space of the sample chamber 2. With the help of this magnetic field B, the magnetic particles 1 can be manipulated, i.e. be magnetized and particularly be moved (if magnetic fields with gradients are used). Thus it is for example possible to attract magnetic particles 1 to the binding surface 12 in order to accelerate the binding of the moiety labeled with the magnetic particle 1 to said surface.

The sensor device further comprises a light source 21, for example a laser or an LED that generates an input light beam L1 which is transmitted into the carrier 11. The input light beam L1 arrives at the binding surface 12 at an angle larger than the critical angle θ_{c} of total internal reflection (TIR) and is therefore totally internally reflected as an “output light beam” L2. The output light beam L2 leaves the carrier 11 through another surface and is detected by a light detector 31, e.g. a photodiode. The light detector 31 determines the amount of light of the output light beam L2 (e.g. expressed by the light intensity of this light beam in the whole spectrum or a certain part of the spectrum). The measurement results are evaluated and optionally monitored over an observation period by an evaluation and recording module 32 that is coupled to the detector 31.

In the light source 21, a commercial DVD (λ=658 nm) laser-diode can be used. A collimator lens may be used to make the input light beam L1 parallel, and a pinhole 23 of e.g. 0.5 mm may be used to reduce the beam diameter. For accurate measurements, a highly stable light source is required. However, even with a perfectly stable power source, temperature changes in the laser can cause drifting and random changes in the output.

To address this issue, the light source may optionally have an integrated input light monitoring diode 22 for measuring the output level of the laser. The (low-pass filtered) output of the monitoring sensor 22 can then be coupled to the evaluation module 32, which can divide the (low-pass filtered) optical signal from the detector 31 by the output of the monitoring sensor 22. For an improved signal-to-noise ratio, the resulting signal may be time-averaged. The division eliminates the effect of laser output fluctuations due to power variations such that no stabilized power source is required, as well as temperature drift such that no precautions like Peltier elements are required.

In an embodiment, a further improvement is achieved if not (or not only) the laser output itself is measured, but (also) the final output of the light source 21. As FIG. 1 coarsely illustrates, only a fraction of the laser output exits the pinhole 23. Only this fraction will be used for the actual measurement in the carrier 11, and is therefore the most direct source signal. Obviously, this fraction is related to the output of the laser, as determined by e.g. the integrated monitor diode 22, but will be affected by any mechanical change or instability in the light path.

Thus, it is advantageous to measure the amount of light of the input light beam L1 after the pinhole 23 and/or after eventual other optical components of the light source 21. This can be done in any suitable manner such as for example by using a parallel glass plate 24 can be placed under 45° or by inserting a beam splitter cube, e.g. 90% transmission/10% reflection beam splitter, into the light path behind the pinhole 23 to deflect a small fraction of the light beam towards a separate input-light monitoring sensor 22′, or by using a small mirror at the edge of the pinhole 23 or the input light beam L1 to deflect a small part of the beam towards a detector.

FIG. 1 also shows an optional second light detector 31′ that can alternatively or additionally be used to detect fluorescence light emitted by particles 1 which were stimulated by the evanescent wave of the input light beam L1. As this fluorescence light is usually emitted isotropically to all sides, the second detector 31′ can in principle be disposed anywhere, e.g. also above the binding surface 12. Moreover, it is of course possible to use the detector 31, too, for the sampling of fluorescence light, wherein the latter may for example spectrally be discriminated from reflected light L2.

The described apparatus applies optical means for the detection of magnetic particles 1 and the target components by way of non-limiting example only. It should be appreciated that any suitable detection technique for detecting the amount of the labeled moiety bound to the binding surface 12 may be used.

In case of such optical means, the detection technique should be surface-specific to eliminating or at least reduce the influence of background such as of the sample fluid, e.g. saliva, blood plasma, blood serum and so on. This is achieved by using the principle of frustrated total internal reflection which is explained in the following.

According to Snell's law of refraction, the angles θ_{A} and θ_{B} with respect to the normal of an interface between two media A and B satisfy the equation

n_{A} sin θ_{A}=n_{B} sin θ_{B}

with n_{A}, n_{B} being the refractive indices in medium A and B, respectively. A ray of light in a medium A with high refractive index (e.g. glass with n_{A}=2) will for example refract away from the normal under an angle θ_{B} at the interface with a medium B with lower refractive index such as air (n_{B}=1) or water (n_{B}≈1.3). A part of the incident light will be reflected at the interface, with the same angle as the angle θ_{A} of incidence. When the angle θ_{A} of incidence is gradually increased, the angle θ_{B} of refraction will increase until it reaches 90°. The corresponding angle of incidence is called the critical angle, θ_{c}, and is given by sin θ_{c}=n_{B}/n_{A}.

At larger angles of incidence, all light will be reflected inside medium A (glass), hence the name “total internal reflection”. However, very close to the interface between medium A (glass) and medium B (air or water), an evanescent wave is formed in medium B, which decays exponentially away from the surface. The field amplitude as function of the distance z from the surface can be expressed as:

exp(−k\sqrt{n_{A}² sin²(θ_{A})−n_{B}²}·z)

with k=2π/λ, θ_{A} being the incident angle of the totally reflected beam, and n_{A} and n_{B} the refractive indices of the respective associated media.

For a typical value of the wavelength λ, e.g. λ=650 nm, and n_{A}=1.53 and n_{B}=1.33, the field amplitude has declined to exp(−1) ≈0.37 of its original value after a distance z of about 228 nm. When this evanescent wave interacts with another medium like the magnetic particles 1 in the setup of FIG. 1, part of the incident light will be coupled into the sample fluid (this is called “frustrated total internal reflection”), and the reflected intensity will be reduced (while the reflected intensity will be 100% for a clean interface and no interaction). Depending on the amount of disturbance, i.e. the amount of magnetic beads on or very near (within about 200 nm) to the binding surface 12 (not in the rest of the sample chamber 2), the reflected intensity will drop accordingly. In case of a sandwich assay, this intensity drop is a direct measure for the amount of bonded magnetic beads 1, and therefore for the concentration of target molecules. When the mentioned interaction distance of the evanescent wave of about 200 nm is compared with the typical dimensions of anti-bodies, target molecules and magnetic beads, it is clear that the influence of the background will be minimal. Larger wavelengths λ will increase the interaction distance, but the influence of the background liquid will still be very small.

The described procedure is independent of applied magnetic fields. This allows real-time optical monitoring of preparation, measurement and washing steps. The monitored signals can also be used to control the measurement or the individual process steps.

For the materials of a typical application, medium A of the carrier 11 can be glass and/or some transparent plastic with a typical refractive index of 1.52. Medium B in the sample chamber 2 will be water-based and have a refractive index close to 1.3. This corresponds to a critical angle θ_{c} of 60°. An angle of incidence of 70° is therefore a practical choice to allow fluid media with a somewhat larger refractive index. Assuming n_{A}=1.52, n_{B} is allowed up to a maximum of 1.43. Higher values of n_{B} would require a larger n_{A} and/or larger angles of incidence.

It is reiterated that the embodiment of the apparatus of the present invention as shown in FIG. 1 is shown by way of non-limiting example only. The present invention may be applied to any assay-based sensor device that utilizes magnetic actuation to promote the assay formation since the problems addressed by the present invention generally occur in such sensor devices regardless of the implementation details of e.g. the detection means. Detection means utilizing different optical principles, e.g. in case of the moieties further comprising a fluorescent label with the detection means being arranged to detect the amount of fluorescence, or even non-optical principles such as detection means arranged to detect the amount of interaction between the magnetic particles 1 and a generated electromagnetic field may be considered.

In accordance with the present invention, the apparatus, e.g. an assay-based sensor device, further comprises a salt preferably in a dry form for preventing the aggregation of the magnetic particles 1 upon receiving the sample in the sample chamber 2. This is particularly relevant if the moiety comprising the magnetic particles 1 for binding to the binding surface 12 is also present in the apparatus in a dry form, because upon wetting the moiety with the fluid sample, aggregation of the magnetic particles as previously explained can render the assay non-functional.

As shown in FIG. 2, the sample chamber 2 typically comprises an inlet 52 which may comprise a filter 53 for filtering the sample prior to exposing the sample to the dry moiety comprising the magnetic labels 1 and the binding surface 12. In a preferred embodiment, the salt 51 lies together with the moiety comprising the magnetic label 1 in a dry form in the sample chamber 2. The amount of the salt 51 is chosen such that upon adding the fluid sample to the sample chamber 2 via the inlet 52, the salt concentration in the sample is in the range of 0.1-5 M. If the salt concentration is chosen in this range, the irreversible clustering of magnetic particles 1 by the supposed interaction between the magnetic particles 1 and the proteins in the sample is sufficiently reduced. It has been found that the best improvement in the reduction of this clustering is obtained when the salt and magnetically labeled moiety lie together, i.e. are mixed, in a dry form in the sample chamber 2, because the final concentration of the salt 51 in the sample can be better controlled.

Alternatively, the salt 51 may be placed upstream from the moiety comprising the magnetic label 1, i.e. in a location such that the sample wets the salt 51 before wetting the moiety. For instance, the salt 51 may be placed in the inlet 52, or may be placed in the filter 53. The filter 53 may for instance be included for filtering blood cells from the sample.

The sample chamber 2 may be an integral part of the apparatus of the present invention. Alternatively, the sample chamber 2 may be a disposable cartridge facilitating reuse of this apparatus. The binding surface 12 may form a part of the sample chamber 2 (not shown in FIG. 2).

As previously explained, the amount of irreversible aggregation of the magnetic particles 1 in a sample depends on the composition of the sample. In particular, plasma samples show a large variation in aggregation behavior between plasma donors. It has been experimentally established that Na and K salts, and in particular the halide salts thereof effectively reduce the undesirable clustering of the magnetic particles 1 over the full range of samples. In addition, it has been found that for plasma samples that are particularly prone to induce magnetic particle aggregation, thiocyanate salts such as KSCN and guanidine SCN substantially reduce the magnetic particle aggregation in such samples.

It should however be understood that other types of salt may also be used. For instance, Mg halides also significantly reduce the aggregation of magnetic particles in samples having high protein content, although to a lesser extent than the Na and K halide salts.

Also, when determining the presence of concentration of cardiac troponin or parathyroid hormone, it has been found that a combination of KBr and KCl is particularly effective in reducing the aggregation of the magnetic particles in the sample.

The invention is explained in more detail by the following non-limiting examples. It should be understood that other embodiments of the present invention not covered by the selected examples are equally feasible.

### EXAMPLE 1

An experiment was performed in which the size of particle aggregates formed was determined after the application of a magnet for 5 minutes in which various concentrations of salts were added to a 100% EDTA plasma sample. The aggregate size was established using a light microscope and the particles used were 500 nm super-paramagnetic particles 1 coated with monoclonal antibodies to troponin as the target molecule. The results of this experiment are shown in Table I.

TABLE I

| | Average cluster size |
|---|---|
| | (number of magnetic particles) |
| Salt concentration | after application of the |
| in sample | magnetic field to the sample |
| No salt | 4-25 plus some larger aggregates |
| 100 mM NaCl | 1-4 |
| 250 mM NaCl | 1-2/1-4 |
| 500 mM NaCl | 1-2/1-4 |
| 100 mM KCl | 1-2/1-4 |
| 250 mM KCl | 1-2/1-4 |
| 500 mM KCl | 1-2/1-4 |

Table I clearly demonstrates that the addition of NaCl and KCl to the sample significantly reduces the cluster size of the magnetic particle aggregates in the EDTA plasma sample. Only small clusters of no more than four magnetic particles 1 were observed for all salt concentrations.

In the following examples, the effect of salt addition to plasma samples having different types of aggregation behavior is investigated. Three types of plasma samples have been used; good samples giving no substantial clustering of the magnetic particles 1, medium samples giving moderate clustering of the magnetic particles 1 and bad samples giving significant clustering of the magnetic particles 1. The different types of plasma samples were obtained from different plasma donors.

### EXAMPLE 2

Assays were performed using samples from various plasma donors (good, medium, bad) that were spiked with 500 pM of cardiac troponin (cTnI). The test was performed in a disposal cartridge containing dry 500 nm magnetic particles 1 coated with tracer troponin antibodies (anti-cTnI) and a dry buffer consisting of a salt, 4-(2-hydroxyethyl)-1-piperazineethanesulfonic acid (HEPES), sucrose and bovine serum albumin (BSA). The tests were repeated for different types of salt.

The final salt concentration given in the solution was 3M. The assay was performed using a magnetic actuation protocol consisting of 1 minute of incubation of the particles with the sample and 4 minutes of pulsed actuation of the particles at the sensor surface, onto which capture anti-cTnI antibodies are coupled.

Particles bound to the surface are detected using the frustrated total internal reflection principle as explained for the apparatus of FIG. 1. The signal strengths for the sensor were obtained removal of non-bound magnetic particles 1 by the application of a magnetic force directing these particles away from the sensor surface. The results of these tests are shown in FIG. 3, which depicts the sensor signal strength as a function of the various salts added to the good, medium and bad plasma samples, as well as in Table II.

TABLE II
Sensor signal strength (a.u.) as a function of sample and salt type

| Salt | Good plasma | Medium plasma | Bad plasma |
|---|---|---|---|
| — | 48.7 | 18.1 | 4.5 |
| NaCl | 68.8 | 22.4 | 9.3 |
| KCl | 71.6 | 36.3 | 9.4 |
| MgCl₂ | 48.9 | 29.1 | 9.4 |
| KBr | 68.9 | 51.9 | 12.2 |
| KI | 52.9 | 39.2 | 10.5 |
| NaBr | 68.1 | 26.9 | 10.0 |

As can be seen from FIG. 3 and Table II, especially the Na and K salts give a significant improvement of the signal strength for all plasma types, which means that more magnetic labels 1 have been bound to the anti-cTnI antibodies via the cTnI, which indicates a reduction in the inhibitive clustering of the magnetic particles 1. In particular KBr performs well for medium and bad plasma types, where an improvement of around a factor 3 compared to the corresponding sample types to which no salt was added.

### EXAMPLE 3

Assays were performed using samples from good and bad plasma donors that were spiked with 500 pM of cardiac troponin (cTnI). The test was performed in a disposal cartridge containing dry 500 nm magnetic particles 1 coated with tracer troponin antibodies (anti-cTnI) and a dry buffer consisting of a salt, 4-(2-hydroxyethyl)-1-piperazineethanesulfonic acid (HEPES), sucrose and bovine serum albumin (BSA). The tests were repeated for different types of salt. The final concentration of the salts in the solution was 100 mM.

The assay was performed using a magnetic actuation protocol consisting of 1 minute of incubation of the magnetic particles 1 with the sample and 4 minutes of pulsed actuation of the particles at the sensor surface, onto which capture anti-cTnI antibodies are coupled.

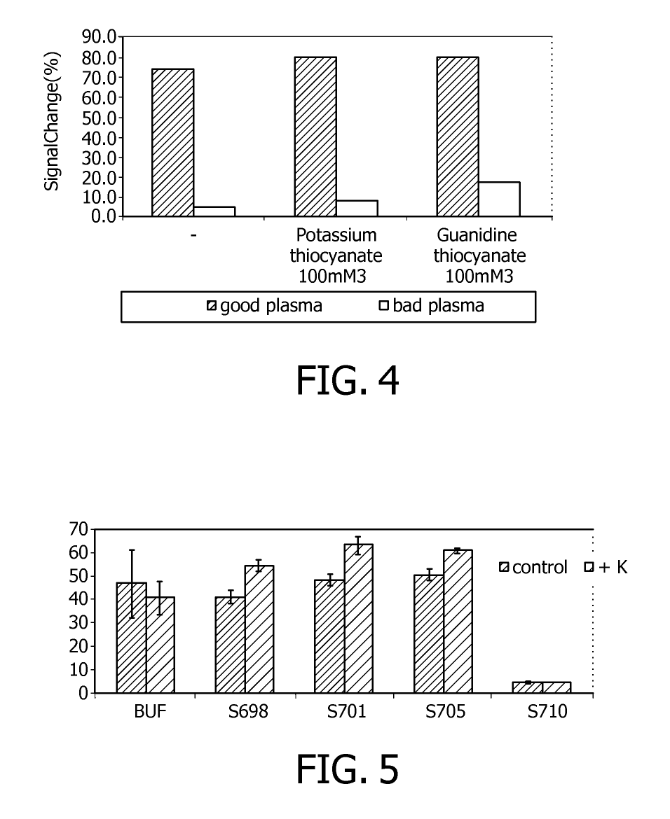

Particles bound to the surface are detected using the frustrated total internal reflection principle as explained for the apparatus of FIG. 1. The signal strengths for the sensor were obtained removal of non-bound magnetic particles 1 by the application of a magnetic force directing these particles away from the sensor surface. The results of these tests are shown in FIG. 4, which depicts the sensor signal strength as a function of the various salts added to the good and bad plasma samples, as well as in Table III.

TABLE III
Sensor signal strength (a.u.) as a function of sample and salt type

| Salt | Good plasma | Bad plasma |
|---|---|---|
| — | 74.2 | 5.1 |
| KSCN | 80.2 | 8.0 |
| Guanidine SCN | 80.7 | 17.6 |

It is clearly demonstrated that thiocyanate salts, and in particular guanidine thiocyanate significantly improve the sensor signal strength in bad plasmas, which means that more magnetic labels 1 have been bound to the anti-cTnI antibodies via the cTnI, thus indicating a reduction in the inhibitive clustering of the magnetic particles 1.

### EXAMPLE 4

Assays were performed using samples from various plasma donors (S698, S701, S705, S710) and a buffer that were spiked with 500 pM of parathyroid hormone (PTH). The tests were performed in a disposal cartridge containing dry 500 nm magnetic particles coated with tracer anti-PTH antibodies and a dry buffer consisting of KCl (1.5 M), HEPES, sucrose and BSA. In the control samples no KCl was added. Each test was performed twice for each sample.

The assay was performed using a magnetic actuation protocol consisting of 2 minutes of incubation of the particles with the sample and 8 minutes of pulsed actuation of the particles at the sensor surface, onto which capture anti-PTH antibodies are coupled. Particles bound to the surface are detected using frustrated total internal reflection as previously explained.

The signal strengths for the sensor were obtained removal of non-bound magnetic particles 1 by the application of a magnetic force directing these particles away from the sensor surface. The results of these tests are shown in FIG. 5, which depicts the average sensor signal strength over the two tests per sample as a function of the various salts added to the various plasma samples and the buffer sample, as well as in Table IV.

TABLE IV
Mean sensor signal strength (a.u.) as a function of sample

| | Control (no KCl added) | With 1.5M KCl |
|---|---|---|
| Buffer | 44.5 | 38.8 |
| S698 | 38.7 | 51.8 |
| S701 | 45.9 | 60.2 |
| S705 | 47.0 | 58.1 |
| S710 | 3.985 | 3.555 |

It can be seen that for all sample types apart from bad sample S710 (it is clear from the poor signal strength for this sample that significant clustering of the magnetic particles 1 occurs in this sample) that the addition of KCl significantly improves the sensor signal strength, which means that more magnetic labels 1 have been bound to the anti-PTH antibodies at the sensor surface via the PTH, thus indicating a reduction in the inhibitive clustering of the magnetic particles 1 in these samples. As expected, no improvement in the signal strength of the buffer solution was achieved due to the absence of protein content in the buffer. This is another clear indication that such protein content in a sample is responsible for the irreversible aggregation of the magnetic particles 1.

Similar improvements have also been obtained in experiments as described above for cardiac troponine I or PHT where the respective antibodies used in the experiments were replaced for those that are indicative for N-terminal proBrain Natriuretic peptide (NT-proBNP). Thus, the invention is likewise beneficial in assays relying on the determination of NT-proBNP.

In short, the above examples clearly demonstrate that the addition of suitable salts to the samples provides a marked improvement in the aggregation behavior of the moieties labeled with the magnetic particles 1.

It is reiterated that the above examples are not intended to limit the scope of the present invention and that many more examples exist, which have not been given for reasons of brevity only. For instance, similar reductions in aggregation behavior have been observed in other high protein containing matrices such as saliva. Hence, the present invention is equally applicable to magnetic particle based assays to detect the abuse of drugs such as THC, morphine, methamphetamine, amphetamine and cocaine in saliva samples. It has been found that in such assays, the addition of e.g. 1M NaCl significantly reduces the aggregation of the magnetic particles 1.

The person skilled in the art will, based on the current description of the invention, be able to recognize other combinations of proteins and the salts that provide the advantages of the invention for the assay based on the required magnetizable or magnetic particles without difficulty.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements. In the device claim enumerating several means, several of these means can be embodied by one and the same item of hardware. The mere fact that certain measures are recited in mutually different dependent claims does not indicate that a combination of these measures cannot be used to advantage.

1. A device configured for receiving a sample, the device comprising:
a moiety indicative for the presence of an analyte in the sample, the moiety comprising a magnetic and/or magnetizable label (1) having a diameter greater than 100 nanometer and
wherein the device further comprises an amount of a salt (51) for dissolving in the sample thereby reducing aggregation of the moiety when in contact with the sample.

2. The device of claim 1, wherein the salt is present in an amount such that the concentration of the salt dissolved in the sample after receipt of the sample is in the range of 0.1-5 Mole per liter.

3. The device of claim 1, wherein the salt (51) is selected to comprise on e or more salts of the group of alkalimetal salts.

4. The device of claim 3, wherein the salt (51) is selected from the group consisting of potassium chloride, potassium iodide, potassium bromide, sodium chloride, and sodium iodide and combinations thereof.

5. The device of claim 4, wherein the salt comprises a combination of potassium bromide and potassium chloride.

6. The device of claim 1, wherein the salt (51) is a thiocyanate salt.

7. The device of claim 6, wherein the thiocyanate salt is selected from the group consisting of potassium thiocyanate and guadinine thiocyanate.

8. The device of claim 1, wherein the moiety is indicative for cardiac disorders.

9. The method of claim 1, wherein the moiety comprises or is a mono-clonal and/or polyclonal antibody indicative for one or more of cardiac troponine I or T, NT-proBNP or PHT.

10. The device of claim 1, wherein the amount of salt (51) and the moiety are present in the device as solid material before application of a sample to the device.

11. The device of claim 1, further comprising a sample inlet (52) connected to a sample chamber (2), wherein the amount of salt (51) is placed in the inlet.

12. The device of claim 11, wherein the inlet (52) comprises filtration means (53) for filtering the sample, wherein the filtration means comprises the amount of salt (51).

13. The device of claim 1 further comprising a binding surface for binding the moieties and detection means for detecting the presence of bound moieties.

14. The device of claim 13 further comprising a magnetic field generator (41) for attracting the magnetic and/or magnetizable labels to the binding surface.

15. A method of determining the presence of an analyte in a sample, comprising the steps of:
providing a moiety comprising a magnetic and/or magnetizable label (1) and having a diameter greater than 100 nm,
providing a binding surface for binding the moiety, the bound moiety being indicative for the presence of the analyte in the sample,
contacting the sample with the moiety, and
measuring the presence of moiety on the binding surface to determine the presence of the analyte, and
in which method an amount of a salt (51) for reducing aggregation of the moiety in the sample is dissolved in the sample before or at least during measuring.

16. The method of claim 13 wherein the sample comprises at least one of blood blood plasma and a blood serum.

17. The method of claim 15, wherein the salt comprises a combination of potassium bromide and potassium chloride, and wherein the moiety is selected to be indicative for the presence of one or more of cardiac troponin I or T, NT-proBNP and parathyroid hormone.
